(19) United States
(12) Patent Application Publication
(10) Pub. No.: US 2016/0170206 A1
(43) Pub. Date: Jun. 16, 2016

(54) GLASS OPACITY SHIFT BASED ON DETERMINED CHARACTERISTICS

(71) Applicant: Lenovo (Singapore) Pte. Ltd., Singapore (SG)

(72) Inventors: Christopher Miles Osborne, Cary, NC (US); Aaron Michael Stewart, Raleigh, NC (US); John Weldon Nicholson, Cary, NC (US); John Miles Hunt, Raleigh, NC (US)

(21) Appl. No.: 14/568,527

(22) Filed: Dec. 12, 2014

(51) Int. Cl. G02B 27/01; G02F 1/153; G06T 19/00; G02F 1/163

(52) U.S. Cl. CPC G02B 27/0172; G02F 1/163; G02F 1/153; G06T 19/006; G02B 2027/0118; G02B 2027/014

(57) ABSTRACT

One embodiment provides an apparatus including: a head mounted display device; a processor; a memory device that stores instructions executable by the processor to: display information; detect at least one predetermined characteristic; and adjust the opacity of at least a part of the head mounted display device, based on the at least one predetermined characteristic. Other aspects are described and claimed.

### BACKGROUND

As technology has advanced, people have been striving to find more natural ways to augment their innate abilities and enhance their surrounding environment. One of the major changes within the last decade that highlights this strategy is the proliferation of the smartphone. The smartphone grants people instant access to a vast collection of information found on the Internet. The natural progression of technology has taken information access from our desks to our pockets and now to our bodies. The implementation of wearable technology has become a new key focus within the technology sector both for the consumer marketplace, the healthcare marketplace, and the commercial and industrial marketplace.

### BRIEF SUMMARY

In summary, one aspect provides an apparatus comprising: a head mounted display device; a processor; a memory device that stores instructions executable by the processor to: display information; detect at least one predetermined characteristic; and adjust the opacity of at least a part of the head mounted display device, based on the at least one predetermined characteristic.

Another aspect provides a method, comprising: displaying, on a head mounted display device, information; detecting, using a processor, at least one predetermined characteristic; and adjusting, using the processor, an opacity of at least a part of the head mounted display device based on the at least one predetermined characteristic.

A further aspect provides a product, comprising: a storage device having code stored therewith, the code being executable by the processor and comprising: code that displays on a wearable device display, information; code that determines at least one predetermined characteristic; and code that adjusts the opacity of the wearable display device based on the at least one predetermined characteristic.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of shifting glass opacity based on content.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As is the case with the majority of new technologies vast room for improvement exists. One of the major areas available for improvement involves the clarity and quality of the user's view. Currently available methods of wearable technologies (e.g., Google's ‘GOOGLE GLASS’ or Epson's ‘MOVERIO BT-200’) can have visibility issues in bright areas or in areas where the background environment shares a prominent color with the information being displayed on the screen. In both of these scenarios, the content being displayed will become washed-out or cause eye fatigue as the users attempts to discern what is relevant. A solution is needed to enhance the visibility of wearable technology. GOOGLE GLASS is a registered trademark of Google Inc. in the United States and other countries. MOVERIO is a registered trademark of Seiko Epson Corporation in the United States and other countries.

Wearable technology comes in a variety of forms (e.g., wrist watches, fitness trackers, head mounted displays, etc.). One of the most advantageous and emerging types of wearable technology is the head worn wearable technology. Head worn technology can come in many forms and types. A typical head worn device uses a heads up display to present requested or relevant information to the user. The display devices on wearable technology can be of many types. References to a wearable display, heads up display, head worn display, head-mounted display (HMD), or the like are used interchangeably throughout the specification.

Various techniques are used for HMDs, for example, diffraction, holographic, polarized, reflective, projection, active matrix, etc. However, the majority of HMD implementations all share the same major flaw. In order to allow a user to see through the display when not in use, the display or lenses must be transparent or semi-transparent. The images on these devices can become washed out due to bright environmental conditions. The content displayed on the devices can be hard to view when looking at or through a clear display background as implemented in most HMDs. Poor image contrast can lead to eye fatigue when attempting to determine where the displayed images begin and the background ends.

Thus, a solution is needed that improves the ability of HMDs to display information to the user. Accordingly, an embodiment provides variable opacity to a wearable display. For example, in an embodiment some types of content are more suitable for viewing with an opaque background. Accordingly, an embodiment changes a display lens that is usually transparent to be opaque, e.g., by use of an electrochromic film or an electrochromic substance within the display device itself. The electrochromic material can change the opacity and color of the display, most commonly to black, by applying an electrical charge to it. By way of example, if a user were viewing pictures or map data, the background could become shaded, blacked-out, or a particular color to better enable the user to view the information.

In addition to poor contrast and eye fatigue, there are social concerns presented with the use of a HMD. Many times, a user will need to read or examine the information displayed on the HMD for an extended period of time. This can cause issues for the user and those around them. For example, although a user may be reading information displayed on the display, it can appear to others that the user is awkwardly staring in a particular direction or at a particular person. This could lead to third parties feeling uncomfortable or confrontational toward the user. Thus, an embodiment uses the electrochromic properties to increase the opacity of the lenses or prisms of a wearable device. By darkening the lens, they could avoid the appearance of staring at a particular person or area.

The illustrated example embodiments will be best understood by reference to the figures. The following description is intended only by way of example, and simply illustrates certain example embodiments.

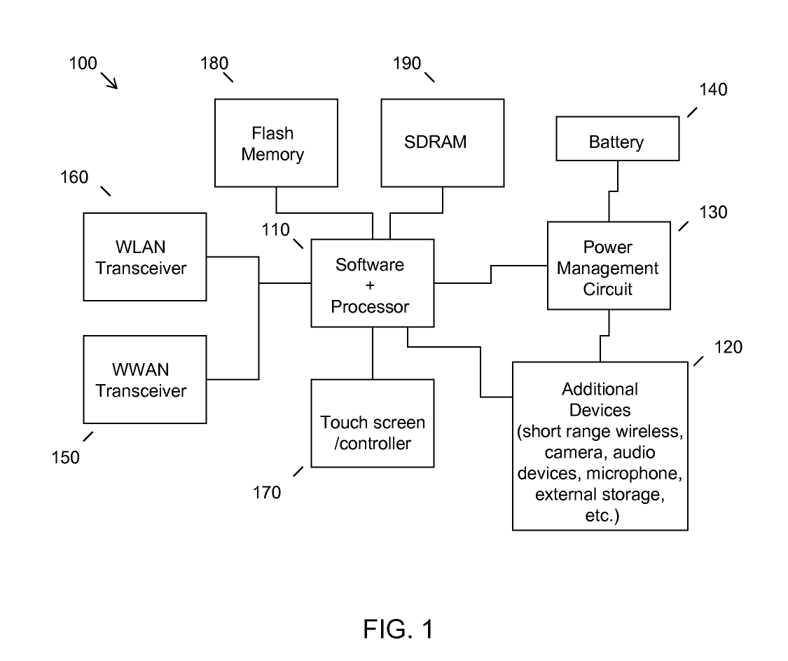

While various other circuits, circuitry or components may be utilized in information handling devices, with regard to smart phone, tablet or wearable device circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering, although this particular display may be replaced by one or more display lens in the case of wearable glasses. System 100 also typically includes various memory devices, for example flash memory 180 and SDRAM 190.

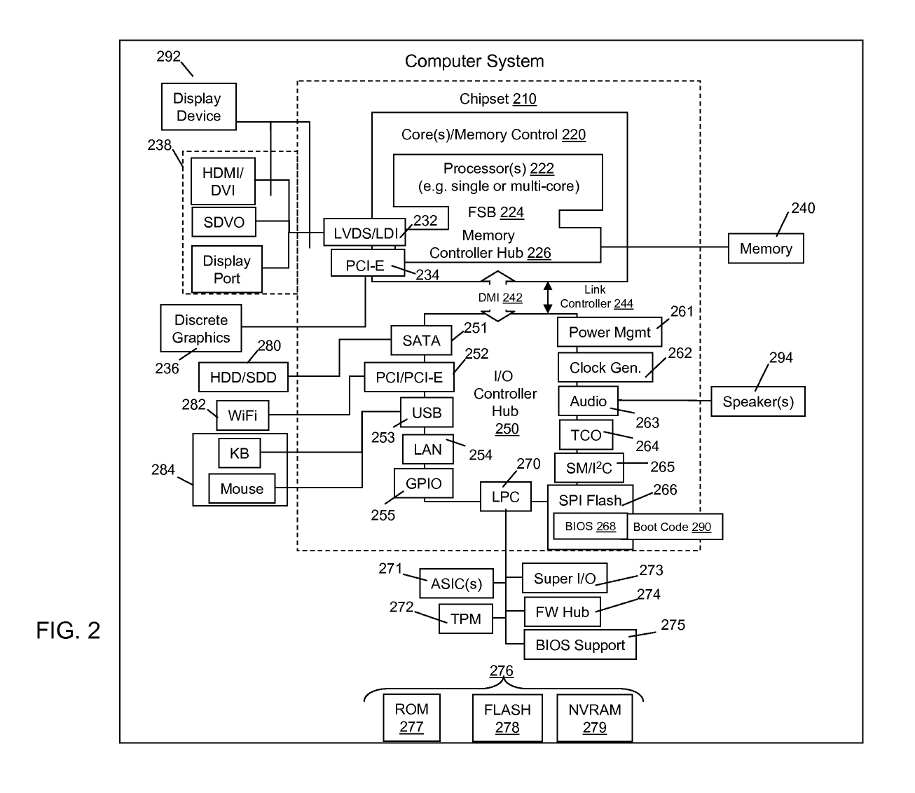

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally. Certain aspects of the circuitry outlined in FIG. 1 or FIG. 2 may be included in wearable technology, e.g., wearable glasses with built in display(s), and/or electronic devices which wearable devices communicate to form a system. For example, the circuitry outlined in FIG. 1 may be implemented in a tablet, wearable device, or smart phone embodiment, whereas the circuitry outlined in FIG. 2 may be implemented in a personal computer embodiment with which a wearable device communicates.

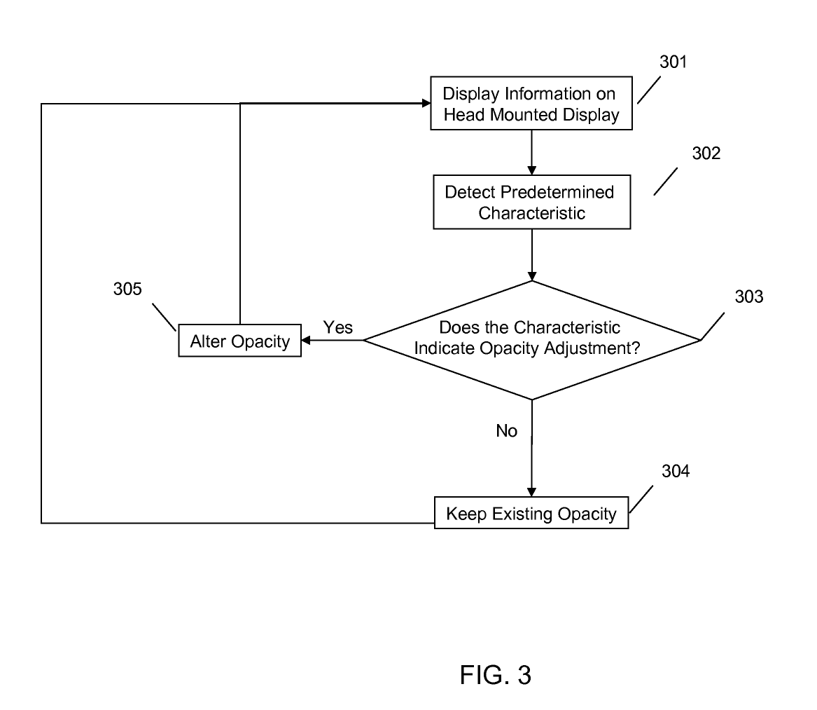

Referring now to FIG. 3, in an embodiment, a head mounted display device displays information to a user at 301. The information could take the form of text, images, web pages, or the like. Additionally, the information could be relevant to a current task being carried out by the user (e.g., navigation to a destination or instructional video on some detailed task).

Once the information is displayed on the HMD, an embodiment may detect a characteristic of the content being displayed at 302 (e.g., an image is being displayed, text is being displayed, the information being displayed is confidential in nature, etc.). An embodiment may then utilize the detected characteristic to determine if a change the opacity is appropriate at 303. For example, an embodiment may change the opacity of the display (e.g., tint, blacken, or change the color of the display) based on the content being displayed, the lighting or other environmental characteristic detected at 302. Once the determination is made to change the opacity, an embodiment may alter the opacity of the lens or background on which the information is displayed at 305. This may be accomplished, for example, by applying or removing a charge to an electrochromic substance in the lens used for the display. If the characteristic of the content is not of the type that requires or is associated with an alteration of the opacity, the HMD display may not be altered. 304

In an embodiment, the opacity of an HMD may be altered using electrochromism or an equivalent technology (e.g., photochromic, thermochromic, suspended particle, mico-blind, liquid crystal devices, etc.) at 305. Electrochromism is a property some materials possess that allows them to change color or tint when a burst of electrical charge is applied, which may be supplied by an embodiment via a rechargeable battery. Electrochromic technology may be applied to normally transparent materials like glass or acrylic. Referred to as smart glass or smart windows, it gives the glass the ability to change from transparent to translucent, thus blocking all or certain particular wavelengths of light.

In a further embodiment, the electrochromic properties are attained through the use of molecular dyes or an equivalent process. Typically, some amount of electrochromic material is placed between two transparent electrodes. The two transparent electrodes are then placed between two glass substrates. This creates the illusion that the smart glass is just an ordinary glass pane, however when current is applied to the transparent electrodes, the electrochromic mixture changes its opacity and thus the opacity of the glass substrates.

Alternatively, an embodiment may achieve an electrochromic property from the application of a film (e.g., SMART TINT). SMART TINT is a registered trademark of Smart Tint, Inc. in the United States. Similar in concept to automobile window tint, an electrochromic film and an electrode file are typically applied to an existing piece of glass. Current can be applied to the electrodes via small contacts. Similar to the above outlined method, the film then changes its opacity depending on the current applied.

In an embodiment, environmental factors of the area surrounding the user during the time the information is displayed may be taken into account. For example, an optical sensor could detect a bright environment (e.g., being outdoors on a bright day or being in an overly lit room), e.g., as a detected characteristic at 302. The background opacity of the HMD may be adjusted at 305 to better enable a user to view the information being displayed in such a context.

The wearable display's opacity might be adjusted according to other environmental characteristics. For example, if the surrounding area is overly loud, that could be used as a characteristic detected at 302 to indicate that a user is in a crowded or busy area. By way of example, if a user needs to study the information displayed on the screen for long periods of time and the user is in a crowded area (e.g., an airport, sporting event, etc.) the user may wish to have the display opacity altered to keep bystanders from assuming they are awkwardly staring in a particular direction. Due to the static transparency of most conventional HMD devices, others may perceive the user as staring at them and not be aware that the user is actually reading material on a HMD. In order to better avoid these awkward social encounters, an embodiment would darken the lenses or background of the display to avoid the appearance of the user staring at others. As such, an embodiment may determine at 303 that the opacity should be increased at 305 for privacy or social reasons.

As another example, may determine at 302 that the content being displayed is textual or complex in format, thus determine at 303 that the HMD opacity should be altered at 305 to better enable the user to focus on interpreting and comprehending the information. This may be appropriate apart from the prevailing environmental context, as certain content is easier to perceive/view with an opaque background.

Location information, e.g., derived from a global positioning system (GPS)), may be used to identify a location characteristic at 302. This location characteristic may be used to determine the location of the wearable device and determine at 303 that the opacity is to be adjusted at 305. By way of example, a user could enter a known location where the user prefers to view detailed images or information that is difficult to see using a transparent display. Thus, the HMD may alter the opacity at 305 when this location is detected.

An embodiment may detect a location characteristic at 302 in the form of a network connection. For example, when a user device is within the proximity of a known wireless network, the HMD may alter the opacity of the display device based on the network detection. By way of example, a user (e.g., a doctor, home owner, etc.) could enter an area that has a wireless network present (e.g., a hospital, their home, etc.), and based on the wireless network identification the opacity may be shifted based on a likely intended use. For example, if a radiologist enters a portion of the hospital with a particular wireless network that allows access to all recent x-ray charts, the HMD could recognize his location and likely task and alter the opacity of the display accordingly. Similarly, a home owner may connect to his or her home network, which triggers a presentation of information regarding their personal calendar and corresponding opacity shift at 305.

Additionally, other device sensors (e.g., accelerometer, 9-axis sensor, etc.), may be used to detect characteristics at 302 from which opacity changes may be determined at 303. For example, through a global navigation satellite system, a device may detect that the user is traveling (e.g., by bus, taxi, etc.) while watching video. In order to improve the user's picture quality for the movie and/or prevent awkward social encounters, the HMD could darken the display, enhancing the contrast of the video or images and shielding the user's eyes from view.

Additionally or alternatively, an embodiment may detect a characteristic at 302 in the form of user input. The user input may be provided by a user pressing a toggle button, giving a voice command, or the like. By way of example, a user could simply press a button to toggle “sunglasses mode,” which would adjust the opacity and tint the glasses to protect the user's eyes from bright sunlight or to reduce glare. Alternatively, a user (e.g., doctor, executive, etc.) could issue a voice command to enter a particular mode for viewing particular content (e.g., X-ray examination mode, presentation viewing mode, etc.). When the particular mode is active, a predetermined setting for the opacity of the HMD may be activated at 305. This allows a user to control the opacity, with or without the use of their hands, and greatly increases the customizability of the device.

An additional embodiment, may detect a characteristic at 302 in the form of an incoming communication. For example, a user that receives a text message or has an incoming call may prefer to be alerted of the incoming communication via alteration of the opacity of the HMD at 305. This form of alert may be used as a more recognizable alert to a user as compared to a vibration or notification sound.

The nature of the opacity change or alteration implemented at 305 may take various forms. For example, the opacity may change only slightly, perhaps in an effort to simply reduce glare or operate as sunglasses. As another example, the HMD could alter the opacity in the form of providing various colored backgrounds. By way of example, if a user planned to be in front of a computer monitor or television set for an extended period of time, he or she may wish to alter the view of the HMD to mimic the yellow tinted look of the computer or gaming glasses designed to reduce eye strain. A similar process may take place when engaging in outdoor activities. Many activities can have specific glass tints, shades, or colors that enhance the wearer's vision.

In an embodiment, a user may wish to have a restriction threshold for how much of an opacity change is allowed. By way of example, if a user wanted to ensure that the HMD would never completely block all of their sight, they could set a threshold of opacity (e.g., 75 percent). This pre-set threshold would also reduce the chance of a mirroring effect that can take place when lenses are completely blackened. Some people experience discomfort when a mirrored surface is placed so closely to their eye.

An embodiment may be made up of multiple independent sections of the HMD. These sections may have their respective opacity altered independently of one another. By way of example, a lens may be formed in sections, where each section is independently controlled (e.g., powered, charged). This would allow for a gradient pattern or for partial tinting of the lenses or lens sections. Additionally, an embodiment may use the independent sections to more naturally transition between the different levels of opacity. By way of example, the independent sections of the HMD could darken or tint at different intervals. The time delay between opacity changes may allow for a more natural feel to the HMD opacity shift.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. Apparatus comprising:
a head mounted display device;
a processor;
a memory device that stores instructions executable by the processor to:
display information;
detect at least one predetermined characteristic; and
adjust the opacity of at least a part of the head mounted display device, based on the at least one predetermined characteristic.

2. The wearable device of claim 1, wherein the at least one part of the head mounted display device comprises an electrochromic material, and wherein the opacity is adjusted via altering a charge to the electrochromic material.

3. The apparatus of claim 2, wherein the electrochromic material is selected from the group consisting of: a film and a layer deposited between two glass substrates.

4. The apparatus of claim 1, wherein the adjusting comprises adjusting the opacity of a plurality of wearable display device sections individually.

5. The apparatus of claim 1, wherein the predetermined characteristic is content type being displayed on the wearable display device.

6. The apparatus of claim 1, wherein the predetermined characteristic is at least one environmental factor.

7. The apparatus of claim 1, wherein the predetermined characteristic is a location of the wearable display device.

8. The apparatus of claim 1, wherein the predetermined characteristic is user input.

9. The apparatus of claim 1, wherein the predetermined characteristic is a wireless network.

10. The apparatus of claim 1, wherein the predetermined characteristic is an incoming communication.

11. A method, comprising:
displaying, on a head mounted display device, information;
detecting, using a processor, at least one predetermined characteristic; and
adjusting, using the processor, an opacity of at least a part of the head mounted display device based on the at least one predetermined characteristic.

12. The method of claim 11, wherein the at least one part of the head mounted display device comprises an electrochromic material, and wherein the opacity is adjusted via altering a charge to the electrochromic material.

13. The method of claim 11, wherein the adjusting comprises adjusting the opacity of a plurality of wearable display device sections individually.

14. The method of claim 11, wherein the predetermined characteristic is content type being displayed on the wearable display device.

15. The method of claim 11, wherein the predetermined characteristic is at least one environmental factor.

16. The method of claim 11, wherein the predetermined characteristic is a location of the wearable display device.

17. The method of claim 11, wherein the predetermined characteristic is user input.

18. The method of claim 11, wherein the predetermined characteristic is a wireless network.

19. The method of claim 11, wherein the predetermined characteristic is an incoming communication.

20. A product, comprising:
a storage device having code stored therewith, the code being executable by the processor and comprising:
code that displays on a wearable device display, information;
code that determines at least one predetermined characteristic; and
code that adjusts the opacity of the wearable display device based on the at least one predetermined characteristic.
